(19) United States
(12) Patent Application Publication
(10) Pub. No.: US 2025/0335558 A1
(43) Pub. Date: Oct. 30, 2025

(54) Method and System for Sharing Online Accounts Without Security Credentials

(71) Applicant: Youssef Ghassan AlHomsi, Salmiya (KW)

(72) Inventor: Youssef Ghassan AlHomsi, Salmiya (KW)

(21) Appl. No.: 18/648,389

(22) Filed: Apr. 28, 2024

(51) Int. Cl. G06F 21/31

(52) U.S. Cl. CPC G06F 21/31

(57) ABSTRACT

This invention relates to a system and method for securely sharing online accounts without disclosing login credentials. The innovation introduces a comprehensive framework that includes a capture module for collecting session data, a duplication module for creating a duplicate account, a configuration module for customizing access settings, a communication module for securely transmitting access details, and an access control module to manage interactions with the target account. The system leverages web browser extensions for data capture, employs unique identifiers for account linkage, and utilizes a desktop application for centralized management. It facilitates secure account sharing by enabling the configuration of permissions, monitoring user activities within the duplicate account, and presenting these activities via a dedicated dashboard, all without compromising the original account's credentials. This approach ensures that authorized users can access shared online accounts securely, with defined restrictions on their actions, thereby enhancing privacy and security in digital interactions.

### BACKGROUND

This invention resides in the technical field of digital security and authentication. More specifically, it pertains to methods and systems for securely sharing online account access without disclosing login credentials.

Conventional methods of sharing online account access typically involve the direct exchange of usernames and passwords, which introduces significant security vulnerabilities, such as the risk of credential theft and unauthorized account access. To counter these threats, various technological advancements, like one-time passwords (OTPs) and encryption techniques for protecting wireless network credentials, have been developed. For instance, the (U.S. Pat. No. 9,563,757) by Assa Abloy AB introduces a system that employs cryptographic indirection to conceal the credentials of the sharing entity from those authorized to use them. Similarly, “Wireless credential sharing” (U.S. Pat. No. 11,233,779) by Apple Inc. outlines a method for securely transmitting credentials between devices to facilitate authentication without exposing sensitive information, thereby enhancing user convenience and security.

However, while these innovations represent significant steps forward in digital security and privacy, focusing on safeguarding login credentials and enabling secure credential sharing, they do not fully address the broader challenge of sharing online account access in a manner that entirely eliminates the need for exchanging sensitive login details. Existing solutions, though beneficial in specific scenarios like network access or the distribution of digital credentials, still often rely on some form of credential exchange or are limited to particular contexts.

There remains a significant gap in securely sharing access to online accounts without directly sharing login credentials, which is crucial for businesses and individuals who need to share account access with others while maintaining security and control over their digital assets.

The primary objective of this invention is to provide a method and system for securely sharing online account access without the need for disclosing login credentials. This includes capturing session data to create a duplicate account accessible to authorized users, configuring access control settings to limit actions within the shared account, and ensuring that access is securely communicated and monitored.

This invention offers a novel approach to account sharing by eliminating the need to share sensitive login information, thus reducing the risk of credential theft and unauthorized access. By leveraging a combination of session data capture, duplication, and secure communication, the system ensures that account owners retain full control over who accesses their accounts and what actions they can perform, significantly enhancing security and privacy in digital environments.

In conclusion, this invention addresses a critical need in the field of digital security by providing a secure, efficient, and user-friendly system for sharing online account access. By moving beyond the limitations of existing technologies, it offers significant advantages in terms of security, privacy, and control, making it an important advancement in the protection of digital assets.

### SUMMARY

The present invention introduces a system and method for securely sharing online accounts without disclosing login credentials. This innovation operates within the technical field of digital security and account management, focusing on enhancing user privacy and security online.

Central to this invention is a capture module crucial for capturing session data, cookies, and tokens associated with a user's login to a target online account. The aforementioned module interacts with a duplication module, tasked with creating a duplicate account on a secure platform, thereby eliminating the need to expose the target account's login credentials.

To tailor access according to specific requirements, a configuration module offers the flexibility to modify the duplicate account based on pre-defined access control settings. These settings enable identifying authorized users, defining permitted actions within the target account, and the potential to disable specific features or data access within the target account.

A communication module ensures that the duplicate account is accessible to an authorized user through a secure channel. Furthermore, an access control module ensures that the authorized user can access and interact with the target account through the duplicate account while maintaining strict restrictions on access to the target account's login credentials based on the configurations set via the configuration module.

Enhancements and variations to this system include the integration of a web browser extension within the capture module for data interception, the generation of a unique identifier for the duplicate account by the duplication module, and the inclusion of a user interface for administrators and users alike to facilitate configuration and interaction with the duplicate account.

Notably, the system incorporates an activity monitoring module, a data recording module, and an activity tracking dashboard to provide comprehensive oversight of user activities within the duplicate account, thereby offering an unprecedented level of security and control over shared online account access.

Implemented through a desktop application, this invention provides a centralized interface for managing shared accounts and access control settings, marking a significant advancement in the field of digital account management. The methodological aspect of this invention mirrors the system's structure, offering a step-by-step approach to securely sharing online accounts without disclosing login credentials, from capturing critical login data to enabling secure access for authorized users.

This invention stands out for its novel approach to online account sharing, providing significant advantages over existing technologies by eliminating the need for credential sharing, thus enhancing security and privacy. Its applications span various domains, from corporate environments requiring secure employee access to personal scenarios involving shared subscription services, showcasing its versatility and broad appeal.

### Definition

Browser Extension: For the purposes of the present invention, a “Browser Extension” is herein defined as a software module that is designed to extend the functionality of a web browser. This module is capable of intercepting, capturing, and manipulating web session data, including, but not limited to, cookies, session tokens, and other information pertinent to a user's login session with an online account. The Browser Extension operates within the framework of the web browser's environment, leveraging its API (Application Programming Interface) to interact with web content and user data securely.

### BRIEF DESCRIPTION OF THE DRAWINGS

FIG. 1 depicts a high-level diagram of the system designed for securely sharing online accounts without disclosing login credentials.

FIG. 2 depicts a detailed process flow diagram that outlines the steps involved in securely sharing online accounts.

### DETAILED DESCRIPTION

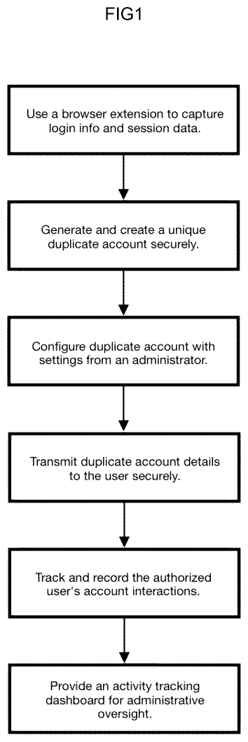

The system's architecture, as visualized in FIG. 1, is designed for the secure sharing of online accounts. It outlines the flow and interaction between various specialized modules, ensuring that login credentials remain undisclosed throughout the process. The figure includes modules comprising:

Capture Module: This module employs packet sniffing and web scraping techniques to intercept and capture session data, cookies, and tokens during the user's login process. Technologies such as Wireshark for packet sniffing and Selenium or Beautiful Soup for web scraping could be used. The module integrates with browser APIs to monitor login events, using SSL pinning to secure the captured data.

Duplication Module: Upon capturing the necessary session data, this module uses a combination of RESTful APIs and secure database management systems (DBMS) such as PostgreSQL or MongoDB to create a duplicate account within a secure, isolated environment. This process involves generating a unique identifier (UUID) for the duplicate account, linking it to the original account while ensuring data integrity and isolation. The use of containerization technology, such as Docker, can provide an isolated environment for each duplicate account, enhancing security and scalability.

Configuration Module: This module utilizes a combination of JSON or XML for defining access control settings and a rules engine (e.g., Drools) for translating these settings into machine-readable instructions. It interacts directly with the Duplication Module to apply these configurations, using API calls to modify the duplicate account's settings based on administrator inputs. The module ensures that only authorized changes are made, employing OAuth for secure API interactions.

Communication Module: Responsible for the secure transmission of duplicate account details to the authorized user, this module implements advanced encryption protocols such as TLS 1.3 for data in transit and AES-256 for data at rest. It can leverage secure messaging services or email with end-to-end encryption using ProtonMail to communicate the details, ensuring that the communication channel remains confidential and tamper-proof.

Access Control Module: This module enables the authorized user to interact with the duplicate account without exposing the original account's login credentials. It uses role-based access control (RBAC) or attribute-based access control (ABAC) models to enforce predefined access control settings. Integration with solutions like OAuth can facilitate seamless and secure user access, while Multi-Factor Authentication (MFA) mechanisms enhance the security posture by verifying the user's identity.

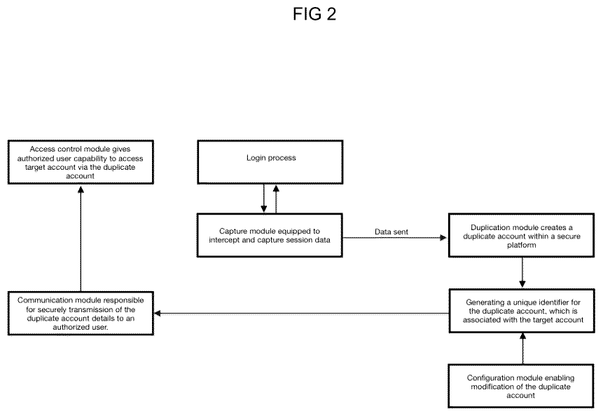

The process flow diagram in FIG. 2 charts the sequence of actions for securely sharing online accounts, with steps comprising:

Capture of Session Data: Utilizing a custom web browser extension developed with JavaScript, this step leverages APIs such as chrome.webRequest (for Chrome extensions) to intercept and capture essential login information such as session data, cookies, and JWT tokens. The extension ensures encryption of the captured data before it is transmitted to the server for processing, utilizing AES encryption standards.

Creation of Duplicate Account: This phase employs a secure server-side application, developed using frameworks such as Node.js or Django, to generate a unique identifier for each duplicate account using UUIDs. The duplicate account is then created within a secure, isolated environment on the platform, leveraging containerization technologies such as Docker for enhanced security and scalability. The secure platform may use NoSQL databases such as MongoDB for flexible data storage or SQL databases like PostgreSQL for structured data, ensuring the integrity and confidentiality of the data without providing direct access to the original account's login credentials.

Configuration of Duplicate Account: Configuration management is handled by a backend service, which applies pre-defined settings received from an administrator. These settings are defined in a JSON configuration file and processed by a configuration management tool such as Ansible, which applies them to the duplicate accounts. This step ensures that the duplicate account mirrors the necessary permissions and restrictions as specified by the administrator, employing a microservices architecture for efficient, on-the-fly configuration updates.

Communication with Authorized User: Secure communication of the duplicate account details to the authorized user is achieved through encrypted email or messaging services. This could involve the use of secure email providers such as ProtonMail or encrypted messaging apps such as Signal, utilizing end-to-end encryption protocols (E2EE) to safeguard the data during transmission. Additionally, the system could integrate with secure file transfer protocols such as HTTPS for the transmission of any necessary configuration files or credentials.

Monitoring and Recording User Activity: This crucial step involves the use of activity monitoring software that integrates with the duplicate account environment. Technologies such as Elasticsearch for logging, combined with Kibana for visualization, can track and record the authorized user's interactions. These tools capture detailed logs of actions taken and data accessed within the duplicate account, supporting real-time monitoring and analysis.

Activity Tracking Dashboard: The presentation of recorded user activities to the administrator is facilitated through a dashboard interface developed with web technologies like React, integrating with backend services to fetch and display the activity logs. This dashboard provides comprehensive insights and control over the shared account usage, featuring customizable alerts and reports enabling administrators to efficiently oversee and manage access to shared accounts.

The embodiments described above are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A system for securely sharing online accounts without disclosing login credentials, comprising: a capture module configured to capture session data, cookies, and tokens associated with a user's login to a target online account; a duplication module configured to create a duplicate account on a secure platform without providing access to the target account's login credentials; a configuration module enabling modification of the duplicate account based on pre-defined access control settings, comprising identifying authorized users, defining permitted actions within the target account, and optionally disabling specific features or data access within the target account; a communication module configured to communicate the duplicate account to an authorized user through a secure channel; and an access control module configured to enable the authorized user to access and interact with the target account through the duplicate account, while restricting access to the target account's login credentials.

2. The system of claim 1, wherein the capture module comprises a web browser extension configured to intercept and collect session data, cookies, and tokens during the user's login process.

3. The system of claim 1, wherein the duplication module further comprises a module configured to generate a unique identifier for the duplicate account and associate it with the target account.

4. The system of claim 1, wherein the configuration module further comprises: a user interface accessible to an administrator for defining access control settings; a processing unit configured to translate the received access control settings into machine-readable instructions; and a control unit configured to apply the instructions to configure the duplicate account's permissions and restrictions.

5. The system of claim 1, wherein the communication module further comprises a communication protocol module configured to transmit the duplicate account's identifier and access information to the authorized user through an encrypted communication protocol.

6. The system of claim 1, further comprising: an activity monitoring module configured to monitor user activity within the duplicate account; a data recording module configured to record user actions and accessed data; and an activity tracking dashboard configured to present the recorded information to the administrator.

7. The system of claim 1, wherein the system is implemented through a desktop application that provides a centralized interface for managing shared accounts and access control settings.

8. The system of claim 1, wherein the system further comprises: a user interface accessible to the authorized user for interacting with the target account through the duplicate account; and a control unit configured to enforce the defined access control settings and restrict unauthorized actions within the target account.

9. A method for securely sharing online accounts without disclosing login credentials, comprising: capturing session data, cookies, and tokens associated with a user's login to a target online account; creating a duplicate account on a secure platform without providing access to the target account's login credentials; configuring the duplicate account based on pre-defined access control settings, including identifying authorized users, defining permitted actions within the target account, and optionally disabling specific features or data access within the target account; communicating the configured duplicate account to an authorized user through a secure channel; and enabling the authorized user to access and interact with the target account through the duplicate account, while restricting access to the target account's login credentials.

10. The method of claim 9, wherein the capturing step further comprises utilizing a web browser extension to intercept and collect session data, cookies, and tokens during the user's login process.

11. The method of claim 9, wherein the creating step further comprises generating a unique identifier for the duplicate account and associating it with the target account.

12. The method of claim 9, wherein the configuring step further comprises: receiving access control settings from an administrator through a dedicated user interface; translating the received access control settings into machine-readable instructions; and applying the instructions to configure the duplicate account's permissions and restrictions.

13. The method of claim 9, wherein the communicating step further comprises transmitting the duplicate account's identifier and access information to the authorized user through an encrypted communication protocol.

14. The method of claim 9, further comprising the step of: Monitoring user activity within the duplicate account; recording user actions and accessed data; and presenting the recorded information to the administrator through a dedicated activity tracking dashboard.

15. The method of claim 9, wherein the method is implemented through a desktop application that provides a centralized interface for managing shared accounts and access control settings.

16. The method of claim 9, further comprising: providing a user interface accessible to the authorized user for interacting with the target account through the duplicate account; and enforcing the defined access control settings and restricting unauthorized actions within the target account.
